(19) United States
(12) Patent Application Publication
(10) Pub. No.: US 2010/0145728 A1
(43) Pub. Date: Jun. 10, 2010

(54) INTEROPERABILITY PLATFORM

(75) Inventor: Isaac Azancot, Paris (FR)

Correspondence Address: HARNESS, DICKEY & PIERCE, P.L.C., P.O. BOX 828, BLOOMFIELD HILLS, MI, 48303, US

(73) Assignee: ASSISTANCE PUBLIQUE-HOPITAUX DE PARIS, PARIS (FR)

(21) Appl. No.: 12/513,647

(22) PCT Filed: Nov. 6, 2007
(86) PCT No.: PCT/FR07/01827

§ 371 Date: Jan. 26, 2010

(30) Foreign Application Priority Data
Nov. 6, 2006 (FR) 0609665

(51) Int. Cl. G06Q 50/00; G06F 15/16

(52) U.S. Cl. 705/3; 709/238; 709/246

(57) ABSTRACT

The present application relates to a computer system for processing customized medical records comprising dedicated equipment for the acquisition of specialized information, as well as, for each healthcare facility, of aggregation equipment for the centralization of the information in view of delivering a customized medical record formed from information coming from said dedicated equipment, and for the distribution of the customized medical records to various operators acting on behalf of at least one healthcare network, characterized in that it comprises an interoperability platform having computer connectors configured for the exchanges between said interoperability platform and each of the aggregation equipment of said healthcare facilities, and computer connectors configures for the exchanges between said interoperability platform and each of said operators, wherein said platform comprises means for conditional routing to one of said operators depending on the information registered in relation to the digital file corresponding to the customized medical record and means for transcoding said file according to the nominal format of said target operator.

### CROSS-REFERENCE TO RELATED APPLICATIONS

This application is a National Phase Entry of International Application No. PCT/FR2007/001827, filed Nov. 6, 2007, which claims priority to French Patent Application No. 06/09665, filed Nov. 6, 2006, both of which are incorporated herein by reference.

### BACKGROUND AND SUMMARY

The present invention relates to a computer system for processing customized medical records. It more particularly relates to a global system interconnecting several networks of health care institutions, for example a network of the personal medical file type, and a network of the cancerology connecting file type. Each one of these institutional networks of health care institutions use one or several authorized health operators generally indicated as “operators” hosting—according to the specifications drawn up by the legislator or the promoters of said networks of health care institutions—the information published by the various health actors and enable a secure consulting thereof by authorized parties.

Various solutions for managing medical records are known in the state of the art. The international patent WO9815910 describes systems and methods suitable for a confidential, protected global electronic medical record which is managed by the subscriber and likely to be updated. The systems and methods, which are used in networks, relate to medical information on the subscriber on line, the access to the information being limited to the subscriber or an authorized user only, thanks to the network address and a password. These systems and methods are more particularly suitable for medical treatments relating to subscribers travelling abroad, with the systems including a logo giving the network address of subscriber's global electronic medical record or of global electronic medical record servers. The password is communicated by the subscriber to the authorized user who must have access to the subscriber's global electronic medical record. According to the preferred embodiment, only the subscribers' medical information hosted by the global electronic medical record servers can be obtained whereas according to a more preferred embodiment, accesses to institutional servers or servers of other medical sites make it possible to obtain complementary medical information relating to the subscriber, which medical information must be incorporated into the subscriber's global electronic medical record. According to the most preferred embodiment, the global electronic medical record which is hosted on the web includes hypertext links between the parties to the subscriber's global electronic medical record.

The international application WO06072700A2 relates to an intermediation server for the consultation and referencing of medical information relating to patients and stored in a computer network of a plurality of data servers including means for creating a shared medical record for a patient listed in the network, and means for indexing, under the patient's medical record, medical information relating thereto, the indexing of medical information including at least one pointer to the location in the network where it is physically stored (WO9641288A1). A bank for the central archiving of medical records, within the scope of the management of a health care institution, collects and stores medical record documents in any format supplied by providers of medical services. The archiving bank then identifies the document using information which is automatically extracted therefrom, and stores the extracted data into a document database. It creates the link between the document and the patient by extracting from this document demographic data identifying the patient and matching them with data stored in a patients' database. Data are automatically extracted from medical records containing a non structured text or a free text using an identification of conventional components of an organization in the text, then ordered through the execution of rules extracting data using such information. Documents relating to a patient are found by identifying him/her with demographic data.

The problem entailed in the solutions of the prior art is that of exchanges between various networks of health care institutions and the interoperability of such networks. As a matter of fact, each network collects health data from pilot sites and places them at the patient's disposal (the patient owns the file) and at the disposal of health care providers authorized by the patient. These health care providers are more particularly public or private health care institutions with a variable size (from a consulting room downtown to an organization grouping several hospitals) which will secure the transmitted medical information composed by documents (hospitalization reports, surgery reports, miscellaneous reports or correspondence of any kind relating to the patient), by images or structured information (such as medical procedures, diagnostics, allergies, risk factors, events, active treatments etc.) relating to the patient. One of the major conditions for guaranteeing the fluidity of the system and its appropriation by the health care providers is that the feeding of the customized medical report and more generally the networks of health care institutions can be automated and integrated in the professional tools also already used or to be used in the health care institutions.

In the state of the art, more or less “manual” procedures are most often provided for supplying the customized medical record: the health care professional wanting to feed the customized medical report must then identify him/herself with the operator of the network of health care institutions, select the patient concerned and add the document or documents which is or are in his or her computer, into his/her own institution network or in the trade software. This means more or less important extra work according to the configurations, but which is always the source of a redundant input and a waste of time which will be refused by most health care professional during the phase of generalization of the project and the increase in the number of information transmitted.

Even though a protocol enabling an automated sending is used between a health care institution equipped with an appropriate information system and the operator with whom it works during the experimentation phase, the protocol will not solve the problem and will somehow make it worst for the following reasons:

A given health care institution can receive patients from various geographic origins and it will then have to work during the generalization phase with all the selected operators. A protocol valid for an operator will not necessarily be suitable for another operator, considering the multiple formats which are the subject of medical standardization, multiple possible references for characterizing the attributes of the sending.

A given patient can change operators in the course of his or her life; the data relating to him or her shall then have to be transferred from one operator to another operator and all the health care institutions which will deal with this patient shall have to adapt their sending, as a function of this new operator.

When an automatic sending is addressed to a given operator, if this sending is not appropriate for any reason whatsoever, more particularly because one or several compulsory attribute(s) is/are not mentioned or is/are not exact in their syntax or in their content (for example: the word “hospitalization report” may not be interpreted as the hospitalization report in the absence of a common and accurate reference which characterises without any ambiguity the nature of the published document), the reject notified by the operator to the health care institution may not be understood and processed adequately by the latter.

The customized medical record is the only first large scale network implemented on a national scale; others will follow soon more particularly DCC which is at present in preparation and other large networks to be implemented for the coordination of care on a national scale. A given health care institution shall have to transfer certain documents to several networks (for example the hospitalization report to the customized medical record and to the DCC) but some other documents will be transferred to only one of them (for example the pluridisciplinary concertation report to the DCC, but not to the customized medical record or cardiological images to the customized medical report and not to the DCC). The health care institutions on the territory will be lost, in the long run, as regards their strategy and their routing syntax opposite the multiple care networks which such or such patient may belong to and opposite the multiplicity of operators which can host each of these patients.

However, the situation will become all the more difficult to manage since orders will be placed implying various health care institutions, various networks of health care institutions and various operators which will have, for each of them, drawn up their own supplying protocols which are more or less in compliance with medical standards. The situation may then start a process which can be called an organized cacophony, which is a process difficult to fix when it is implemented and running by contract with miscellaneous operators.

The aim of the invention is to remedy the drawbacks of the state of the art and more particularly the problem of interoperability. The aim of the method which is the subject of the present invention is the implementation of an interoperability platform enabling 1/to guarantee the standardization of information and facilitating the deployment of the standards and the references selected by the various health care providers implied 2/automatically routing to the appropriate receiver the flow of information originating from the health care institutions about standards, references and attributes of information common to all the institutions participating in the networks of health care institutions 3/providing traceability and management of the flows of health information, with the double aim of facilitating the management of networks of health care institutions and improving the quality of services and cares.

The above-mentioned method relies on existing architectures of computerization of health care institutions based on standards and references chosen in the field of health to provide an organization model for the management of flows with the aim of improving exchanges of health data between heterogeneous environments, optimizing automation, the appropriate routing and protection of the supply of networks of health care institutions from health care institutions. It will provide the industrialists which will implement an interoperability platform based on the method described in this document to provide the health care institution a new service making it possible to guarantee that medical information is routed to the appropriate operators and that it can be processed appropriately by said operators. Therefore, the invention in its broadest sense relates to a computer system for the processing of customized medical records including equipment dedicated to the acquisition of specialized information as well as—for each health care institution—aggregation equipment for the centralization of information with a view to supplying a customized medical record composed from information issued by said dedicated equipment, and for the distribution of customized medical records to various operators acting for at least one network of health care institutions, characterised in that it includes an interoperability platform providing computer connectors configured for exchanges between said interoperability platform and each aggregation equipment in said health care institutions and computer connections configured for exchanges between said interoperability platform and each one of said operators, said platform including means for the conditional routing to one of said operators as a function of the information recorded in relation with the digital file corresponding to the customized medical record and means for code converting said file according to the nominal format of said target operator.

The invention also relates to a method for processing customized medical files including a step of creating digital files from digital data issued by various equipment for the acquisition of information relating to patients, said step being executed on an aggregation equipment belonging to a health care institution having said acquisition equipment and forming a network of health care institutions, characterised in that the method includes an initial step of declaring each network of health care institutions, this initial step including a declaration of operators implied with the platform including a description of the type of information supplied by said network of health care institutions and the attributes of said information as well as the structure of the document supplied by the equipment in said network of health care institutions. Preferably, each document is digitally signed upon the creation or the modification by the operator, with said document being enciphered according to a code not known to the interoperability platform.

### BRIEF DESCRIPTION OF DRAWINGS

The invention will be better understood upon reading the following description which relates to a non limitative exemplary embodiment and referring to the appended drawings wherein:

FIG. 1 shows a schematic view of an architecture according to the state of the art;

FIG. 2 shows a schematic view of an architecture according to the invention; and

FIG. 3 shows a diagram for code converting carried out by the interoperability platform.

### DETAILED DESCRIPTION

The system according to the invention implements known technical means and more particularly a document release portal enabling the automated release of documents, images and structured data. Such a portal can implement a method of aggregation of documents released by medical applications described in the French patent FR04/52604. It makes it possible for any release tool, in a health care institution, to export documents, images and structured data by using a safe technology of structured attributes envelopes in compliance with medical standards and references. The format of the information is in compliance with the international standard HL7 and more particularly the international IHE/XDS profile associated with the device developed by group GT11 of the EDISANTE association indicating the format of attribute envelopes (CDA R2). In addition to the standards used for the communication of information, references lead to a common syntax and list making it possible to characterize the attributes of the documents, such as the categories of the documents or medical procedures, diagnostics, risk factors, medical events, allergies etc.

The routing of information is provided in a secure and traceable way, without providing the archiving of the information itself, more particularly the P2P (Station to Station) architecture which is secure and centralized. In this architecture, a health care institution connects to a server managing the sharing, searching and insertion of information although information is directly transmitted from the health care institution to the health operator or operators. As they are provided with miscellaneous enciphering system, these tools provide the users a perfect confidentiality in their exchanges. According to the method which is the subject of the present invention, a centralized P2P is operated based on one or several servers which the health care institutions can connect to, which provide a routing of attributes of documents and structured information towards the appropriate operator or operators, but do not know the content of the documents or the information themselves.

Each patient is identified by a “patient national identifier”. Various works and recommendations have already been made for several years on a national scale and a regional scale. The final national specifications making it possible to check the identity of the patient which subscribes with the Répertoire National Inter-Régime de l'Assurance Maladie (Health Insurance interscheme National Directory), to create with the Caisse des Dépôts et Consignations (Consignments and Loans Funds) and to obtain a health identifying number (NIS in the following part of the document), to obtain from a DMP host a health quality address (AQS), are being finally validated within the scope of the experimentation phase of the customized medical record.

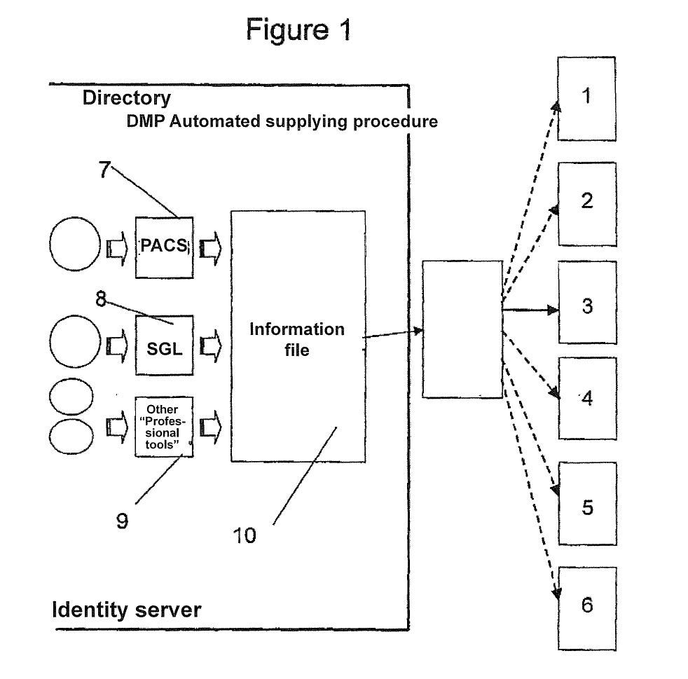

FIG. 1 illustrates the operation of a health care institution using an automated release tool, standards references and one NIS for routing towards various operators the information intended to supply one or several network or networks of health care institutions. The information to be communicated to one or several operators (1 to 6) originating from the various “professional tools” 7, 8, 9 of the health care institution are included in the patient's information record, more particularly but not exclusively:

Imaging reports and images in the DICOM format originating from an archiving and image communication system 7 (PACS);

Biological results issuing from a laboratory managing system 8 (SGL);

Other professional tools: any kind of records more particularly hospitalization and consulting records, care reports, structured medical information (history, allergies, risk factors, active treatments etc) supplied by inputting equipment 9.

This information is processed in the information file and is validated to be released for one or several operators: this validation is carried out using an electronic signature which makes it possible to identify the health professional to authorize, validate and release the information with respect to a corporate directory. The information is thus routed to the concerned operator 3.

Several problems may result from such a type of operating architecture:

Permanent updating in all the health care institutions and/or in all the hosts of information coupling patients and hosts: it will always be difficult or even impossible for all the health care institutions implied in the various network of health care institutions to know with accuracy which network of health care institutions a given patient belongs to, which the concerned operators are for each network of health care institutions, which are the information to be transmitted to this or that operator and which are the formats (3-1-2) and references (3-1-3) adopted by the various operators within the various concerned networks for the exchanges of information with the health care institutions.

Homogeneous processing of rejects (in case of non-compliance of a sending): when, whatever the reason, an unsuitable information reaches an operator, the latter will reject it according to a syntax which—in the absence of a consensus in the processes and the syntax of rejects of information—may not be understood by the emitting health care institution.

Appropriate transfer of a document or a file from one host to another: when some given information is transmitted by error to one operator or when the patient changes the operator, it will be necessary to route the information from one operator to another one which will raise problems of operability as discussed hereabove.

Incorporation of new interoperability standards (imaging, structure elements): as network of health care institutions are by nature dynamic, and any new information which must be incorporated in the network of health care institutions will correspond to new attributes (what are the networks of health care institutions concerned?) what are the formats and corresponding references?) which shall have to be communicated to all the health care institutions and to all the operators concerned.

Such logistic problems will be raised for all the health care providers for appropriately routing the information: issues mentioned hereabove show, in this type of operation, logistic difficulties which may become insurmountable when and as the content and the number of networks of health care institutions to be interconnected increase.

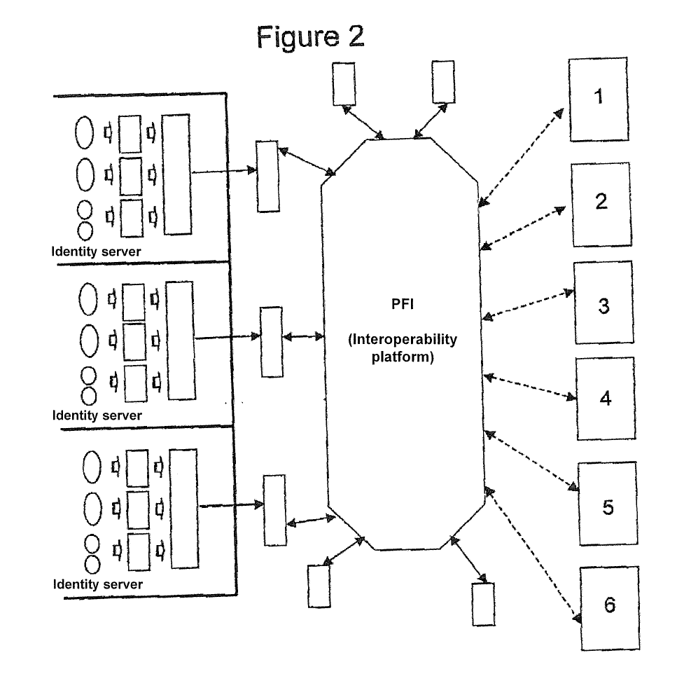

FIG. 2 illustrates the operation of a system which uses an automated release tool in a health care institution, standards, references and an NIS for routing to various operators the information intended to be supplied to one or several network(s) of health care institutions within the scope of the utilization of an interoperability platform according to the invention. The operation diagram and the method for implementing a system according to the invention are as follows.

First, the networks of health care institutions are declared in the interoperability platform: each network of health care institutions which must be managed by the interoperability platform must be declared as a network taken into account. This declaration implies the taking into account of the attributes of information taken into account by said network of health care institutions, operators concerned by the deployment of said networks and patients having subscribed to the network of health care institutions through an authorized operator. The operators will more particularly have to communicate to the platform—directly or through a network of health care institutions which they belong to—the subscription of new patients belonging to the corresponding network, based on their NIS, or the termination of the subscription of previously subscribing patients.

Then the definition of information attributes will have to be made: each network of health care institutions declared in the interoperability platform must communicate to the interoperability platform all the operators implied in the network of health care institutions, the type of information relating to said network (documents, images, structured information), and for each of such information, the attributes of said information, these attributes being based on the references chosen for said network, more particularly but not exclusively:

the types of the documents taken into account, each type of document (for example: hospitalization report, consulting report, surgery report, imaging report etc) being defined by a unique code originating from a reference;

The nature of the communication of images and more particularly with a view to the identification with respect to each imaging procedure:

The imaging procedures exported from an institution DICOM server to the DICOM operator server, each of these procedures being identified by a single DICOM identifier;

The procedures which must be directly displayed on the DICOM server of the health care institution through an internet link which an internet explorer points to or the exported images as a file (JPEG type format) representing an enclosure (refer to the paragraph hereinunder on the links between documents) to the main document (the imaging report);

The links between the documents more particularly with a view to differentiating:

The main document containing information (for example: the hospitalization report);

The enclosure or enclosures to the main document (for example a letter accompanying a hospitalization report or one or several JPEG images going with an imaging report);

The successive revisions of the same document so as not to consider as a new document a revised document: therefore it is possible to affect any document a unique identification number including a chronological revision index making it possible to associate the successive revisions of the same documents together and these are associated to an electronic signature corresponding to each revision.

The structured information associated or not to one or several documents, structured information according to the standards and the references chosen by the network more particularly with a view to identifying:

The patient's identity attributes based more particularly on the NIS and enabling a patient's identification on a national scale;

The health care institution identification attributes more particularly when the signature of the document or the information uses an identification certificate of the health care institution;

The identification attributes of the person who signed the document or the released information, the professional's identification being either:

individual: in this case, the identification of the health care professional uses the individual's CPS card;

collective: in this case, the health care institution signs the information but the professional signing each released information is identified more particularly with respect to a feeding directory of health care institutions (making a unique identification of an health care professional inside an health care institution possible);

The medical attributes going or not with the document, these attributes making reference to codes originating from references making it possible to classify them into categories (for example, but not limitatively: “diagnostics” category based on a CIM10 reference, “procedures” category based on a CCAM reference, “allergies” category based on a SNOMED reference, etc). This procedure makes it possible to classify the structured information with respect to categories identified by unique codes and with respect to codes inside each category based on a precise reference. The network can then adopt a unique reference (for example SNOMED), or be based according to the categories of attributes on multiple references with each of the information being connected univocally to one category into one code.

The system includes an organization of information: this definition method which gives the attributes of information relatively to standards and to well-defined references for each network of health care institutions enables a pertinent classification of the information and prevents a disorder which might result from a stacking of non-classified documents with respect to attributes, and such documents would become difficult to consult. Each health care institution using the health care interoperability platform directly communicates information to be released through one or several network(s) of health care institutions to the interoperability platform according to the diagram of FIG. 2, with the health care institution which can be more particularly but not limitatively public or private hospital structures, biology or imaging laboratories, pharmacy or medical rooms using professional software. This diagram implies a minimum level of equipment in each health care institution which must be provided with tools making it possible to publish the medical information and integrate the corresponding attributes to each of this medical information. The precise definition of the information released by each health care institution is the subject of a contract binding the health care institution with the service provider implementing the interoperability platform which thus:

Collects all the data relating to all the information (documents, images, structured information) which can be released by the health care institution and identifies all the network of health care institutions which the health care institution wishes to subscribe to.

As a function of the information relating to all the networks in which the health care institution wishes to take share, transmits the health care institution all the specifications relating to the standards and the references used by the interoperability platform for the definition of the attributes of the various released information, as well as the communication and protection standards making it possible to route the information to the interoperability platform. It provides the health care institution or the publishers software made available to the health care institution and software layers required for standardizing the release of the information with respect to the standards and references used in the interoperability platform. This software support can, depending on the cases, be directly provided by the provider of the interoperability platform or by third party editors providing this function under the supervision and the control of the provider of the interoperability platform.

It should be noted that the interoperability platform does not know the content of the information (for example the content of a document) but only the attributes of the information. The protected and centralized technologies used in the “P2P” architectures can more particularly be used for providing the encryption and the fluidity of the transactions, even under the assumption that an interoperability platform carrying out several millions of transactions per day is used. The operation of the interoperability platform then follows the following procedure:

The health care institution releases some information: this release is automatically triggered by the signature of information (for example the signature of a report or an imaging document including a link with the DICOM server of the health care institution or the image exporter and/or the release of structured information.
In the release header of each document or information, the health care institution defines the network or networks of health care institutions which the patient wished to subscribe to, and his or her agreement on the information being routed to said network(s) of health care institutions. This authorization is generally collected in the health care institution which implements the release of information to one or several network or networks of health care institutions as a patient's written authorization—upon a hospitalization or during a predetermined period—for communicating the information relating to him or her to one or several network or networks.

The interoperability platform checks the conformity of the information released with respect to the standards and references implemented with the health care institution. The interoperability platform more particularly checks the patient's identifying parameters and the compliance of this identification with the parameters originating from the national health identification (NIS). In case of non-compliance (missing compulsory attributes, erroneous attributes or non-complying attributes), the interoperability platform sends a reject file and records the history and the grounds for the rejection in its own database—according to a predefined syntax communicated to all the health care institutions using the interoperability platform.

If the information is appropriate, the interoperability platform checks, with respect to the attributes of the information released by the health care institution, what the networks of health care institutions concerned by said information are (this means the networks of health care institutions integrating the information corresponding to the attributes). The interoperability platform carries out a code converting, if need be, for making the input attributes of the information (which are common to all health care institutions) complying with the output attributes which may be different according to the health care institutions, in compliance with the contract binding the health care institution to the interoperability platform. For this purpose, the interoperability platform has the tools required for making the conversion of the standards and/or the references selected in its own platform with those selected in this or that network of health care institutions.

The interoperability platform checks, for each network of health care institutions, which is the operator concerned by said network: for example for DMP, the interoperability platform will update according to the information communicated by the various subscribing health care institutions, the correspondence table between the patients and the operator selected by each patient within the DMP. The interoperability platform then has all the elements for suitably routing, for each patient, the information towards the operator concerned by each network concerned by the information, characterised by its attributes. If the transaction is carried out normally, the interoperability platform records the parameters of said transaction and communicates an acknowledgement of compliance for the transaction and the routing carried out to the concerned operator or operators as per a standardized format.

If one operator rejects the information, the interoperability platform analyses the ground for the rejection. If one solution can be brought by the interoperability platform, the latter reroutes the information and notifies the transaction to the health care institution. If not so, the interoperability platform routes a standardized reject file to the health care institution. All these transactions must be the subject of a high traceability at the level of the interoperability platform.

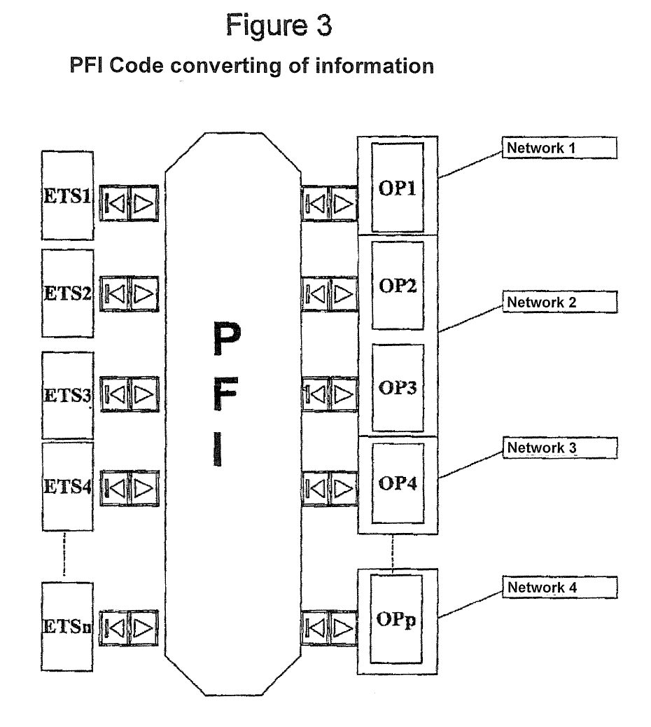

FIG. 3 shows a diagram of the code converting carried out by the interoperability platform. The connectors connect, on the one hand, the health care institutions with the interoperability platform and, on the other hand, the interoperability platform to the operators. Each connector includes an input module and an output module which may correspond to different standards, references and attributes which are symbolized by a color. The health care institutions may not, at the beginning, have attributes complying with those of the interoperability platform. FIG. 3 shows that the interoperability platform upgrades the attributes of the health care institutions with the input standards of the interoperability platform. Then, the interoperability platform executes the code converting, if necessary, of its attributes to the attributes used by each network of health care institutions and if need be by each operator of network of health care institutions if the attributes are not strictly uniform within the same network of health care institutions. All these code converting operations are defined as per their nature and their functions in the contract binding the health care institutions and the operators of the networks of health care institutions on the one hand, and the interoperability platform, on the other hand.

Possible parameters of utilization of an interoperability platform using the methods which are the subject of this document associated service and expected gains.

The implementation of a National interoperability platform makes it possible:

to guarantee that the information released by each health care institution having an interface with the interoperability platform will be automatically routed to the suitable operator of each network of health care institutions which the patient wished to subscribe to, without imposing extra work for the health actors nor extra cost for the development to the editors providing the health care institutions;

that this information will be understood by the operator in spite of the possible difference of the operators and the networks of health care institutions which will probably be implied within a rather long or short term at the national level in the procedure of improvement of the quality of care;

the increase in the quantity of information characterised by the attributes thereof, and by the standards and references which are associated thereto will be progressive when and as the load increase of each network of health care institutions and the multiplication of network of health care institutions, without expecting, as from the beginning, an illusive completeness of the standards in validation progress;

that a traceability of the information flows can be provided in a centralized way, the implications of which can be major as regards the quality of the tracking of the exchanges on health information as well as in the economic procedures implied in the optimization of the redundancy of care and thus in the quality of care.

A strict confidentiality of the information will be guaranteed on the one hand, because of the contract binding the provider of the interoperability platform with the constraints of confidentiality imposed by the government, the relevance of an industrial formality controlled by the legislator; on the other hand, resulting from the fact that only the attributes of information are routed to the interoperability platform and not the medical information as mentioned hereabove.

The implementation of a national interoperability platform makes it possible to create concrete bases, making it possible to define European or international conditions of interoperability, as a function of care policies and tools implemented in the various countries.

However, it may happen that a control at a national level is not implemented or is slowly implemented and the parallel project such as the DMP or DCC are set up in a more or less concerted way, using standards and references which are more or less accurate and more or less common. These ambitious and transversal projects will then entail other projects representing regional or territorial initiatives for the sharing of information within the frame of a network of health care institutions which are of interest more particularly for institutions, scientists association or specialties. In particular, the region can decide to implement an interoperability platform providing the interoperability of exchanges at a regional level however perfectly complying with the national network of health care institutions, thus bringing the various health care institutions concerned a software interface providing the expertise required for implementing a network of health care institutions and the integration of such network of health care institutions in an automated chain supplying and sharing the information. A regional interoperability platform will be, in this perspective, a tool for monitoring and following exchanges of information flows between the various health care providers in the region, which can have important consequences on the quality of care as well as on the medico-economical control. Another alternative to a national or regional control carried out by the implementation at this level of an interoperability platform is that the industrial offer comes before such political decisions by providing: 1/to requesting health care institutions or 2/to institutions grouping several health care institutions or 3/to editors providing several health care institutions new services which are currently necessary for the implementation of network of health care institutions, which cannot be simply covered by the software nor the editors means at the basis of such software tools.

As a matter of fact:

The follow up and taking into account of the various standards and references with a view to standardizing the exchanges of data flows in heterogeneous media, as well as the code converting operations which may be necessary depending on the heterogeneity of the network of health care institutions, as explained hereabove, is a complex issue which requires important logistic and cultural cooperate means, and which some software editors cannot afford. Investing internal means in these technologies would mean a very important cost, even for editors of health solutions having important means. The solution consisting in contacting a provider of an interoperability platform providing important means and a complete organization in this field seems a technically and financially interesting solution.

The provider of the interoperability platform can then implement “connectors” (refer to FIG. 3) as a function of the software equipment in the health care institution having entered the contract with him and the network of health care institutions concerned. These connectors may include document release tools if the health care institution has no such means available or interface the release means in the health care institution or of the editor of the information system in the health care institution with the standards defined by the interoperability platform.

As per the diagram, the interoperability platform thus seems to be an additional software layer—with respect to the operator in charge of a network of health care institutions—in each health care institution or each establishment grouping a certain number of health institutions. With respect to the operators, the information appears as originating from the health care institution, as per the same rules and obligations as those imposed by the legislator for managing such or such network of health care institutions. However, it makes it possible, as in the model of a national or regional interoperability platform, to provide the health care institution with:

That the relevant information is automatically transmitted to the relevant receivers, as a function of the subscription of each patient to such or such network of health care institutions and this in a way which is integrated in the professional tools, in the health care institution, and without any additional charge for the health care providers, in the health care institution.

That the information is understood by any operator, in spite of the possible multiplicity of operators and networks of health care institutions and corresponding standards and references.

That all the guarantees imposed by the legislator as regards the security and the confidentiality of information are taken into account by an industrial structure, the technologies of which are the ground for these guaranties and for which they represent the core activities.

As regards an institution grouping several health care establishments, operational control indicators for the data flows to the various network of health care institutions are available at a centralized level with implications as regards the quality of health and the medico-economic control resulting therefrom.

According to this diagram, an interoperability platform grouping several health care institutions can thus be a relay between said health care institutions and a regional or national interoperability platform.

1. A computer system for the processing of customized medical records, the system comprising dedicated acquisition equipment acquiring specialized information as well as, for each health care institution, aggregation equipment for centralizing information, with the view to feeding a customized medical record further comprising information issued by said dedicated acquisition equipment, the system distributing customized medical records to various operators acting on behalf of at least one network of health care institutions, an interoperability platform further comprising computer connectors configured for exchanges between said interoperability platform and each one of said operators, said platform including a router operably conditionally routing to one of said operators as a function of the information recorded in relation with the digital file corresponding to the customized medical record and a converter operably code converting said file according to the nominal format of said target operator.

2. A method for processing customized medical records implementing a system complying with claim 1, said method comprising creating digital files from digital data issued by the various equipment for the acquisition of information relating to the patients, executed on an aggregation equipment reserved to one health care institution owing said acquisition equipment and forming a network of health care institutions, the method further comprising an initial step of declaring each network of health care institutions, such initial step including a declaration of the operators implied with the platform comprising a description of the type of information supplied by said network of health care institutions and the attributes of said information as well as the structure of the document supplied by the equipment of said network of health care institutions.

3. A method for processing medical records according to claim 2, further comprising digitally signing each document upon the creation or the modification by the operator, said document being enciphered according to a code not known to the interoperability platform.
